(19) United States
(12) Patent Application Publication
(10) Pub. No.: US 2007/0250526 A1
(43) Pub. Date: Oct. 25, 2007

(54) Using speech to text functionality to create specific user generated content metadata for digital content files (eg images) during capture, review, and/or playback process

(76) Inventor: Michael Scott Hanna, Irving, TX (US)

Correspondence Address: Michael Scott Hanna, 2800 Starlake Court, Irving, TX, 75060, US

(21) Appl. No.: 11/379,995

(22) Filed: Apr. 24, 2006

(51) Int. Cl. G06F 7/00

(52) U.S. Cl. 707/102

(57) ABSTRACT

A method for adding user defined metadata to digital files (eg images, video music, etc) is disclosed. The input method for the user-defined metadata consists of using speech to text conversion technology where the user speaks a description of the content, which is then included as metadata with the digital file that was intended. Through the invention described, the metadata is added to the appropriate metadata field(s) of the intended digital content file(s). The addition and editing of metadata can happen before, during or after the digital content capture and/or during the content review process. This functionality allows for a quick, intuitive and user friendly way for users to add specific self-generated metadata content to digital content files (eg digital images). Results include more efficient and enhanced sorting, storing and searching of digital content as well as attaching notes to better describe an image, akin to writing on the back of printed photos.

### FIELD OF THE INVENTION

This invention relates to the field of digital content capture and playback and the adding and editing of metadata to digital files. An example is the capture of digital pictures using a digital camera, and also includes all devices where the user would find benefit in including content metadata.

### BACKGROUND OF THE INVENTION

The area of digital imaging has grown tremendously in recent years and will continue to grow substantially in the years to come. Digital Image capture device sales (including digital cameras and camera phone devices) were an estimated 600 million units in 2005 and will grow even more in the years to come. Resulting from the mass market availability of these image capture devices is a burgeoning collection of digital images that are stored and saved.

Because digital files (e.g. digital pictures) do not inherently have content related text associated with them, it is not feasible to conduct key word searches in the traditional sense as would be the case for Microsoft Word files, PowerPoint files, Adobe PDF's, web pages, E-mails and the like.

Digital files are stored in a variety of formats (images—TIFF, JPEG, etc; video—H.263, H.264, MPEG4, Windows Media, etc; music—AAC, MP3, AAC+, Windows, etc) and in a variety of mediums (e.g. memory cards, Personal computers, online albums, Compact Disks, DVD's, dedicated devices, etc). The sheer and continuing to increase volume of digital content captured and available makes the task of storing and later finding them increasingly more difficult.

To best solve this issue and allow users a way to more easily find their stored digital files (eg digital pictures), metadata can be used. Metadata is definitional data that provides information about a file such as the owner, history, quality, etc. For the purpose of this invention, the focus is on content related metadata which is inputted by the user, in their own words, to describe the targeted digital file that they have captured/stored.

For digital images, it is now common place for most digital image capture device manufacturers to include metadata such as time/date, image size, exposure, device manufacturer and the like to the metadata of each image file captured.

Glaringly absent is an easy and intuitive method for digital camera users to input metadata where the user is adding the specific content related metadata, in their own words, to describe the image(s) or content captured.

For digital pictures, this could be considered similar to the idea of the user writing key words and a description on the back of traditionally printed photographs. For example, “Grandma's 80^{th} birthday. Uncle Carl tickling Mark, Mom, and Dad”. This is the information that the user would like to have permanently associated with this image, where it can be used to describe the scene for future viewing and/or to easily find when doing keyword searches.

The idea of having the user inputted content metadata embedded in the image (or other digital content) file will allow those who view the image to have additional text descriptors that describe the image or content file. This gives those viewing the picture additional valuable insight into the picture and the events thereof. As mentioned, the embedded content metadata also allows for quick and easy searching of the content at a later date.

Most digital camera manufactures capture basic camera and technical information and embed this information directly into the image file. This typically includes information like resolution, date and time, aperture settings, etc. Though this information is useful in a lot of ways, the most important area for most users is not accounted for. This relates to the actual contents or subject matter of the image being captured.
For example: John is at his cousin Stan's Barbeque and is capturing an image of his Father and Mother with his digital camera. He wants to add the metadata (Mom and Dad at Stan's Barbeque in Fresno).
   Currently, there is no easy way for John to do this.

To solve this problem, an easy, flexible and intuitive mechanism is needed to allow users to add this important metadata to digital pictures.

### PRIOR ART

Their have been many previous inventions focused on adding metadata to digital images. Two to note, that are most closely related to the invention being filed are “Embedded Metadata Engines in Digital Capture Devices” (U.S. Pat. No. 6,833,865) and “Integrated Data and Real Time Metadata Capture System and Method” (U.S. Pat. No. 6,877,134). Relating to speech to text functionality for metadata, these inventions are focused on taking an encoded video file/feed, and analyzing the audio portion of it for the inclusion of metadata. This means that when the user (or Hollywood studio) is capturing a video clip, then the audio portion of it will be analyzed for keywords and then phrases and keywords will be extracted via speech to text from that file. Ultimately, the results are added to the file's metadata.

This does NOT address the idea of a user purposely creating and adding metadata to a digital still image (or other content), via speech to text functionality. Specifically and purposely stating the keywords and/or description to be added to the digital files (image, video, music, etc) is the focus of the invention currently being filed. A key point is that the user's creating of metadata and the capturing of the digital content are separate events. Similar as to when the user would capture a still photograph, then write the keywords and description on the back of the photo. Whereas the previous patents mentioned are actually the same event.

In inventions U.S. Pat. Nos. 6,833,865 and 6,877,134, the metadata where speech to text functionality is cited is in relation to the audio portion of captured video. Thus, the metadata is to be extracted from the video that is being encoded. Relating to audio capture, the patents (U.S. Pat. Nos. 6,833,865 & 6,877,134) are specifically focused on the aspect extracting metadata from the audio feed of the video file captured.

Not only is this clear in the description and claims of patents U.S. Pat. Nos. 6,877,134 and 6,833,865, but also in the drawings. For example, drawings 2a and 3 of U.S. Pat. No. 6,833,865, which are the digital camera reference drawings, do not have a microphone.

### SUMMARY OF THE INVENTION

The issue of adding user desired keywords and descriptions to digital content files (images, video, music, etc) is greatly improved upon by the following invention. The invention is to incorporate “speech to text” functionality into the device (eg digital camera), and also image viewing and editing software on personal computers. The incorporated speech-to-text engine will convert the user's spoken word (an audio track), ultimately to a text file, that is included with the image file metadata.

The process by which the audio track is converted to text is one in which someone skilled in this area could easily recreate. A generic digital capture device is pictured in FIG. 1. The audio (spoken word) is captured by the device microphone (10). From the microphone, it is converted to digital format. This can be done through a dedicated piece of hardware (e.g. Analog to Digital Converter) (11) or this can be done on the device processor with specialized Software (12). This conversion of analog to digital depends on the capabilities of the device and the manufacture's chosen device architecture. Once the audio feed is in digital form, it is processed through a Speech to Text engine integrated on the device (14). The speech to text engine can be from any number of 3^{rd} party suppliers. This includes companies such as IBM, OneVoice, VoiceSignal, and many others. The integration and access to the speech to text engine can be done via standard API's and/or through proprietary means specific to each manufacturer.

From the chosen speech to text engine, a text string is outputted. The text string can be any of the standards for text (eg ASCII, UTF-8, ISO8859-8, etc). The text output is determined by the language support needed to support the speech to text. This text string represents the user's spoken word, but in text form. This text string can be reviewed and approved by the user.

This can be done in a variety of ways. One such method is via text to speech capabilities, where the user hears and approves the text. In this model, a text to speech (30) engine is used and the speech is outputted to a speaker (15) on the device.

Another option is to output the text to the device display (18), where the user can read and review the metadata to be added, as well as edit and approve it. Editing could occur with further speech to text input or through another interface (e.g. keypad (16)).

Once the speech is in text format (eg ASCII), then it can be added to the intended image file(s). The content metadata can be added to the image file at any time throughout the image lifecycle. For example, it can be added when the image is encoded, compressed and/or saved. Most likely it will be done at the same time and through the same process the manufacturer uses to add metadata to images currently. This process is shown to be object (25) in FIG. 1.

The addition of metadata to digital files (eg images) can be accomplished by a proprietary means that is specific to each manufacturer and/or metadata can be added using an industry specification. An example of the leading industry specification for adding metadata to digital images is the Exif 'specification(s) from JEITA (Japan Electronics and Information Technology Industries Association). Using the Exif 2.2 specification as a guide, the device manufacturer will add the user specified metadata—via the speech to text functionality as described—to the appropriate content related field(s). In addition, proprietary methods for adding content metadata to image files are covered under the spirit of this invention, as long as speech to txt functionality is employed by the device manufacturer to add said content metadata.

In addition, content metadata can be added to image file(s) during the image review process. This applies to images and digital content that has already been captured on the device, and are being reviewed through the device display. While viewing images on the device display the user will have the option to add/edit “content metadata” to the image file(s).

For this process, the device will support an interface to the image file(s) content metadata field(s). The user then similarly adds metadata through the speech to text process described before. The difference here is that metadata is being added to digital content (eg image files) that have already been stored and saved on the device. For example, the metadata is added to the file(s) that are resident on the device's permanent memory or memory card. An user interface to add the metadata is assumed, and the metadata creation model consists of the same speech to text engine previously described.

In addition, the content metadata adding/editing function can support multiple input interfaces simultaneously.

The device has the capability to support adding Speech to text in a one to one, or one to many fashion. The metadata is added in similar fashion as described above. They ability to add metadata to many images at once is supported through the device user interface (UI), as well as the interface(s) to the content files.

An example of a method for specifying content metadata and subsequently adding said metadata to a group of related images is explained.

Before a birthday party begins and the user begins to capture images, he/she specifies the metadata content “Granny's 80^{th} birthday party in Hawaii” to be added. Subsequently, all content files (e.g. Digital images) captured will have the tag “Granny's 80^{th} birthday party in Hawaii” added to them. To do this, the phrase will initially be converted to the appropriate text format (Eg ASCII) via the speech to text engine, approved by the user and saved to the device memory. As long as the user has this phrase as “active” it will be added to all digital pictures captured. The user can then change or turn off the content metadata function at any time using the device User Interface (UI).

The user can then add their desired content metadata to one or a group of designated images. During the review process, the metadata is created and added through a user interface (UI) on the device, and also the appropriate interface(s) into the image file(s).

A speech to text engine can be sourced from a multitude of 3^{rd} parties (IBM, VoiceSignal, OneVoice, etc), and thus incorporated into the device and interface through standard API's or proprietary interfaces.

The metadata that results from the user's spoken word(s), is added as part of the image file per the EXIF specification, non-standard solutions, or via the image capture device manufacturer's proprietary process.

The end user benefit of this invention is that the user can search for images using most available search engines (eg Google Desktop) and/or many Digital image album software applications (eg. Adobe Photoshop Album) to easily find the images they are looking for once they have been stored. This naturally results in a tremendous time savings and also more accurate searches for the user when searching for digital images.

An example of how this functionality works from a user's perspective is illustrated.
John wants to add the metadata “Mom and Dad at Stan's Barbeque in Fresno” to a digital image he is capturing of his parents.
Through the UI, he enables the function “Add Image Description”, which readies the device to add content metadata.
He then triggers the record function of the device and speaks the words “Mom and Dad at Stan's Barbeque in Fresno”, then triggers the device recording to “off”.
He then reviews the metadata to insure accuracy via the device display or through a text to speech function.
Once the content metadata is what he likes, it is approved, and will subsequently be added to the image John captures.
John then downloads the digital pictures to his personal computer.
Several months later, John is looking for pictures of his Mom and Dad to include in a slideshow.
He types Mom and Dad into his personal search engine (eg. Google Desktop), and is returned all results where Mom and Dad are present.
He easily finds the file taken at Stan's Barbeque and decides to use that picture.

For the image capture device, this functionality is to be incorporated into the device as a feature. The exact implementation will be up to the image capture device manufacturer and software developer. However the key point is that voice to text functionality is utilized to capture the desired metadata for the digital image file(s).
For example, some manufactures may allow the user to turn the feature “on” and “off”. Once turned “on” the user can have groupings where certain key word metadata is added to a series of photographs. This can take place before or after image capture.
In addition, a feature can be enabled that allows the user to add key word(s) to each image on an individual basis.
   This could take place before image capture, or allowed after image capture when the image is being reviewed.
   In addition, a combination can be employed where the user creates a high level description, which is added to every picture as well as adding additional individual metadata content to each image captured.
The process and timing of the keyword capture can be implemented in a variety of ways.
   For example, the digital imaging device could have a dedicated key, that when pressed, the device records the spoken key words, stores them to memory, then adds them to the metadata field(s) as each image is captured and in the way that the user has specified.
Similarly, the user could add metadata (via speech to text) while reviewing pictures on the device's display. The metadata is again added to the chosen field(s) (typically the Content related fields) via the manufactures implementation (proprietary of standard).

The dilemma of having so much digital content that users can not find the digital files (eg images) they are looking for, can be greatly overcome by incorporating speech to text functionality into the digital capture and review process. Speech to text capabilities allow the user to, in their own words, add important key words and descriptive information of the images that they are capturing. These keywords are thus added into the appropriate metadata fields of the image file(s).

The keywords thus included in the image file metadata can be searched for using common search applications such as Google Desktop, Adobe Photoshop Album, etc. This enables quick and accurate searching of digital files by users as well as attaching descriptive information that will always be a part of the image file.

Covered and referenced in the Exif 2.2 specifications are the image formats for TIFF and JPEG images. The Exif Version 2.2 specification and the TIFF Rev. 6.0 Attribute Information standard should be followed when adding metadata to an image file (TIFF, JPEG and other). This invention also applies if the manufacturer chooses to add the metadata via a proprietary or other standard implementation, as long as the metadata is originally generated by speech to text functionality.

### BRIEF DESCRIPTION OF THE DRAWINGS

FIG. 1 is block structure of a digital content capture and/or playback device. The device represents a generic digital camera, camcorder, music device, etc. Of key importance is the ability to use the speech to text engine to generate metadata for the digital content captured and or stored.

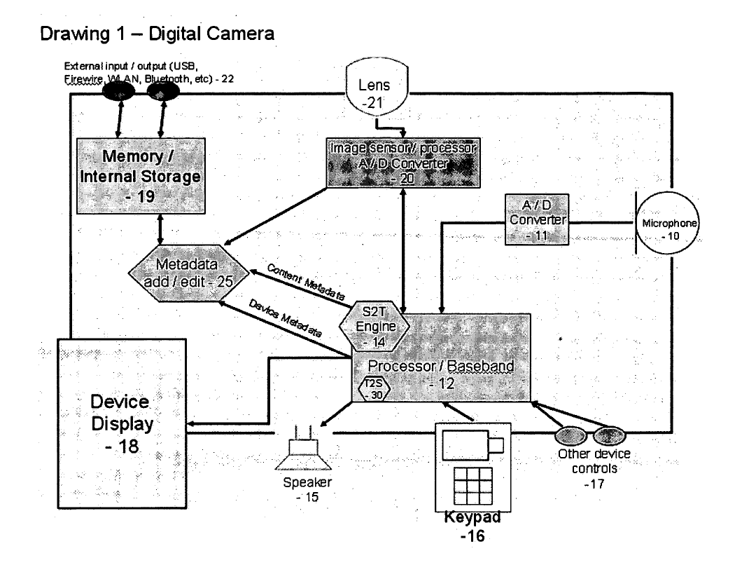

### PARTS LIST

10—microphone

11—analog to digital converter—speech (optional)

12—processor unit/base band

14—Speech to text engine

15—Speaker

16—keypad

17—other device controls

18—device display

19—memory/internal storage

20—image processor/A->D converter

21—lens

22—external connectivity (USB, WLAN, Bluetooth, Firewire, etc

25—Process where metadata is added to digital content

The embodiments of the invention in which an exclusive property or privilege is claimed are defined as follows:

1. A solution that allows for the capture of content metadata that compromises:
a digital capture device that is capable of capturing and/or storing one or more forms of digital content
a speech to text engine integrated within the digital capture device that converts the users spoken word to text
a storage mechanism for the created content metadata text, where the text is stored and added to the intended content file(s) during, after, and/or before the content capture process

2. The system defined in claim 1, additionally compromising the ability for the user to purposely create a description and/or keywords to describe digital content, outside the process of capturing said content, where the content is purposefully created to function as content metadata data for the chosen content file(s)

3. Wherein the intent to generate the metadata is a descriptive interpretation of the content that is captured or will be captured and in the user's desired words

4. Wherein the content metadata is captured using a speech to text engine to convert the users spoken word to text (eg ASCII)
Wherein the generated content metadata that is ultimately converted to text (eg ASCII) is added to the appropriate metadata fields of the image file per the Exif 2.2 specification and/or other standard or non-standard implementations.

5. The system defined in claim 1, additionally compromising a user interface on the image capture device which facilitates the administration and selection of preferences and settings for the user to add and edit the metadata
i. Wherein the interface to add metadata is integrated into the overall function and control of the device
ii. Wherein the user can add metadata to images before, during and after the time of capture
iii. Wherein the user can add metadata to images (or other content) while reviewing them on the device display
iv. Wherein the ability to capture metadata can be turned on, off, or edited at any time
v. Wherein the user can add different levels of metadata to single and also groups of images
1. E.G. an overall metadata tag is selected to be added to a group of images where-in addition, the user can add additional metadata to each image individually

6. The system defined in claim 1, additionally compromising a microphone on the device to capture and record the audio track, containing the users spoken word
i. Wherein the microphone captures the spoken word and via analog to digital conversion, it is relayed to the speech to text engine where the conversion of the voice track to text format occurs
ii. Wherein the audio track captured by the microphone will be converted to digital via an Analog to digital converter and/or software running on the device
iii. Wherein the content metadata in text form is added to the intended digital file(s) as content metadata

7. The system defined in claim 1, additionally compromising a method for the user to review and edit the metadata that has been associated with each image
i. Wherein the user can view the keywords on the device's display and/or listen to the keywords desired via the utilization of text to speech or via some other mechanism

8. The system defined in claim 1, additionally compromising a method for the user to approve the metadata created

9. The adding of the captured metadata to the image file, once the metadata has been converted to text (ASCII or other)
i. Wherein the metadata is added per one of the following methods:
1. The Exif (Exchangeable Image file format) specifications from JEITA (Japan Electronics and Information Technology Industries Association)
2. Dig35 specification from the Digital Imaging Group
3. Flashpix of I3A (International Imaging Industry Association)
4. Any proprietary or non-standard means developed by a computer software company or individual
5. Any proprietary or non-standard means implemented by manufacturers of Digital Image capture devices.

10. The user will have the option through the previously described user interface to add metadata to different categories per the above mentioned methods
i. Wherein, the user can choose the title of the image
ii. Wherein the user can add an image description
iii. Wherein the user can add the author of the image
iv. Wherein the user can add metadata to any number of metadata fields that are in the spirit of content metadata.

11. The system defined in claim 1, additionally compromising a user interface for digital devices (eg. camera display) which allows the user to administer and control the speech to text functionality, to add, edit and delete metadata to images, or groups of images, as desired.

12. A software application on a personal computer that utilizes speech to text functionality, which takes the users spoken words and through the speech to text engine outputs text (eg. ASCII), then through an interface(s) with the desired image file(s) adds the content metadata desired
i. Wherein the speech to text functionality is integrated into a software application, a web based application, or simply through a direct viewing of the image file through an image browsing application
ii. Wherein the content fields where metadata is added are the content fields that relate to image description, user comments, title, author, artist, and the like.

13. The ability to add user generated metadata via the speech to text functionality relates to all digital content, including images (JPEG, TIFF, etc), Video clips (MPEG4, H.263, H.264, AVI, Quicktime, Windows media, etc), Music files (AAC, eAAC+, MP3, Windows Media, etc) and the like.

14. The ability to add user generated metadata via the speech to text functionality relates to all digital devices, including music players, video recorders, digital cameras, personal computers, DVD players, image viewers, and the like.
